(19) United States
(12) Patent Application Publication
(10) Pub. No.: US 2010/0044533 A1
(43) Pub. Date: Feb. 25, 2010

(54) ADJUSTABLE LEG

(75) Inventors: David Russell King, Annandale (AU); Steve Higgs, Lane Cove (AU)

Correspondence Address: Nelson Mullins Riley & Scarborough LLP;IP Department, 100 North Tryon Street, 42nd Floor, Charlotte, NC, 28202-4000, US

(73) Assignee: King Furniture (Australia) Pty Ltd., Turrella, New South Wales (AU)

(21) Appl. No.: 12/504,388

(22) Filed: Jul. 16, 2009

(30) Foreign Application Priority Data
Jul. 17, 2008 (AU) 2008903657

(51) Int. Cl. F16M 11/26

(52) U.S. Cl. 248/188.5

(57) ABSTRACT

Disclosed herein is an adjustable leg (10) for an article of furniture (70). The adjustable leg (10) includes a receptacle (12) defining a plurality of receiving formations (16) and a post member (20) displaceably received in the receptacle (12). The post member (20) carries an engaging element (22) which is selectively releasably receivable in one of the receiving formations (16) of the receptacle (12). The engaging element (22) is responsive to an operating member (24) for making and breaking engagement between the engaging element (22) and the selected one of the receiving formations (16) of the receptacle (12).

### CROSS-REFERENCE TO THE RELATED APPLICATIONS

The present application claims priority from Australian Provisional Patent Application No. 2008903657 filed on 17 Jul. 2008, the content of which is incorporated herein by reference.

### FIELD

The present disclosure relates, generally, to an article of furniture and, more particularly, to an adjustable leg for an article of furniture and to an article of furniture comprising the adjustable leg.

### BACKGROUND

There is an increasing trend in modern furniture design to have adjustable furniture. Individual users have different requirements when it comes to the height that a seat of the furniture should be above the floor surface.

Existing systems of which the applicant is aware, such as screw-adjustable feet, are difficult to operate and often do not result in a properly leveled article of furniture.

For higher quality furniture, the ability to adjust the height of the article of furniture above the floor should be effected in an easy-to-operate, accurate and aesthetically pleasing manner.

### SUMMARY

In a first aspect, there is provided an adjustable leg for an article of furniture, the adjustable leg comprising:

a receptacle defining a plurality of receiving formations; and

a post member displaceably received in the receptacle, the post member carrying an engaging element which is selectively releasably receivable in one of the receiving formations of the receptacle and an operating member to which the engaging element is responsive for making and breaking engagement between the engaging element and the selected one of the receiving formations of the receptacle.

The receptacle may be a part of the article of furniture. For example, the receptacle may be a frame component of the article of furniture. Instead, the receptacle may be a sleeve which cooperates with a frame component of the article of furniture. The sleeve may cooperate with the article of furniture by being received in a socket of the frame component of the article of furniture.

The receptacle and the post member may be shaped to inhibit relative rotation between the receptacle and the post member. The post member may be of prismatic form having a polygonal cross-section and the receptacle may define a passage of complementary cross-section. The post member may be of rectangular (including square) cross-section.

At least one of the receptacle and the post member may comprise a bearing surface of a low friction material to facilitate sliding displacement between the receptacle and the post member. Typically, the receptacle is of a suitable synthetic plastics material. The post member may be of a metal material.

The receptacle may have at least one face in which the receiving formations are arranged. Each receiving formation may be in the form of an opening defined in the face. The openings may be arranged in aligned, longitudinally spaced relationship in the face of the receptacle. The openings may be circular in shape to receive a complementarily shaped engaging element of the post member.

The post member may comprise at least one pair of opposed sides. The engaging element may project through a first side of the pair of opposed sides of the post member and the operating member may project through an opposed, second side of the pair of opposed sides of the post member.

The operating member may comprise an operating button projectable through the second side of the post member, the operating button being mounted to one end of a lever arm. The engaging element may be carried by an opposed end of the lever arm. The lever arm may be pivotally arranged within the post member. An urging device which acts on the lever arm may be provided so that, in a rest condition, the lever arm is arranged within the post member so that the engaging element projects from its associated side of the post member. The lever arm and the urging device may be adapted such that depression of the operating button against the action of the urging device disengages the engaging element from the receiving formation and moves the engaging element into the interior of the post member.

The urging device may be interposed between the lever arm and an inner surface of one of the first and second sides of the post member.

The lever arm may be doglegged, having a first part carrying the operating button on a first surface and a second part, arranged at an obtuse angle to the first part, carrying the engaging element on an opposed, second surface. The lever arm may be pivotally mounted, about a pivot point, in the post member at a transition between the first part and the second part, the pivot point being defined by the transition bearing against an inner surface of one of the first and second sides of the post member. The transition may bear against that side of the post member through which the engaging element projects.

The urging device may be interposed between a first surface of the second part of the lever arm and an internal surface of that side of the post member through which the operating button projects. The urging device may be a coil spring. The first surface of the second part of the lever member may comprise a retaining element which retains the coils spring in position.

Both the engaging element and the operating button may be in the form of ball hearings.

In a second aspect, there is provided an article of furniture comprising:

a frame component; and

at least one adjustable leg mounted to the frame component, the adjustable leg comprising:

a receptacle defining a plurality of receiving formations; and

a post member displaceably received in the receptacle, the post member carrying an engaging element which is selectively releasably receivable in one of the receiving formations of the receptacle and an operating member to which the engaging element is responsive for making and breaking engagement between the engaging element and the selected one of the receiving formations of the receptacle.

A further aspect extends also to a component for an adjustable leg, the component comprising:

a hollow body member defining a plurality of faces;

an engaging element contained within the body member to protrude through an opening in a first face of the body member; and

an operating member carried by the body member and which acts on the engaging element to effect displacement of the engaging element relative to the body member, the operating member comprising an operating element accessible through one of the faces of the body member for effecting displacement of the engaging element relative to the body member.

The operating member may comprise an operating button and the operating member may further comprise a lever arm with the operating button being mounted proximate one end of the lever arm and the engaging element being mounted proximate an opposed end of the lever arm.

### BRIEF DESCRIPTION OF THE DRAWINGS

A preferred embodiment is now described by way of example, with reference to the accompanying drawings, in which:

FIG. 1 shows a three-dimensional view of an embodiment of an adjustable leg for an article of furniture;

FIG. 2 shows a rear view of the adjustable leg;

FIG. 3 shows a sectional side view of a part of the adjustable leg;

FIG. 4 shows a three dimensional view of an embodiment of an article of furniture; and

FIG. 5 shows a partly sectioned, side view of a part of the article of furniture.

### DETAILED DESCRIPTION OF THE EXEMPLARY EMBODIMENT

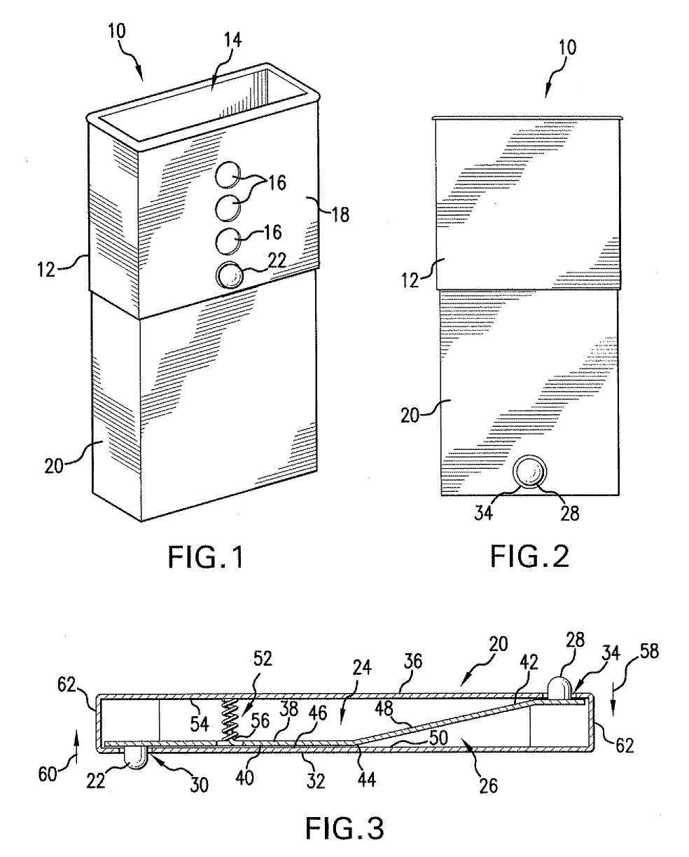

Referring initially to FIGS. 1-3 of the drawings, reference numeral 10 generally designates an embodiment of an adjustable leg. The adjustable leg comprises a receptacle in the form of a sleeve 12 defining a passage 14. A plurality of receiving formations in the form of openings 16 are defined in a wall 18 of the sleeve 12.

The adjustable leg 10 further comprises a post member 20 slidably received within the passage 14 of the sleeve 12. The post member 20 carries an engaging element 22 which is selectively received in one of the openings 16 to adjust the position of the post member 20 relative to the sleeve 12.

The engaging element 22 is carried on an operating member 24 (FIG. 3) which is operable to withdraw the engaging element 22 from one of the openings 16, as will be described in greater detail below. As illustrated more clearly in FIG. 3 of the drawings, the operating member 24 is contained substantially within an interior 26 of the post member 20.

The operating member 26 comprises an operating button 28. The engaging element 22 projects through an opening 30 in a first face 32 of the post member 20. The operating button 28 projects through an opening 34 in an opposed face 36 of the post member 20.

In an embodiment, the engaging element 22 and the operating button 28 are implemented in the form of metal ball bearings. However, any suitable protruding device can be used as the engaging element 22 and the operating button 28, respectively.

The operating member 24 further comprises a lever arm 38. The lever arm 38 is contained within the interior 26 of the post member 20 and carries both the engaging element 22 and the operating button 28. Thus, the engaging element 22 is carried on a first surface 40 of the lever arm 38. The operating button 28 is carried on an opposed surface 42 of the lever arm 38.

The lever arm 38 is cranked defining a transition zone which acts as a pivot point or fulcrum 44 of the lever arm 38. The fulcrum 44 is arranged between a first part 46 and a second part 48 of the lever arm 38, the engaging element 22 being carried on the part 46 and the operating button 28 being carried on the opposed side of the lever arm 38 on the second part 48 of the lever arm 38.

The fulcrum 44 bears against an internal surface 50 of the of the face 32 of the post member 20. The lever arm 38 is retained in a position in which the part 46 bears against the surface 50 of the post member 20 by an urging device in the form of a coil spring 52. The coil spring 52 is arranged to bear against the part 46 of the lever arm 38 and an internal surface 54 of the face 36 of the post member 20. A tab 52 retains the spring 52 in position. The tab 52 is formed by bending a cut portion of the part 46 into a position in which it projects at substantially 90° to the remainder of the part 46 of the lever arm 38.

When the operating button 28 is depressed in the direction of arrow 58, the lever arm 38 pivots about the fulcrum 44 against the action of the coil spring 52 to withdraw the engaging element 22 inwardly in the direction of arrow 60 to disengage the engaging element 22 from the opening 16 of the sleeve 12 in which the engaging element 22 had been located.

The sleeve 12 and the post member 20 are shaped to inhibit rotation relative to each other. Thus, at least the passage 14 of the sleeve 12 and post member 20 are of prismatic form and polygonal cross section. More particularly, as illustrated, the post member 20 is of rectangular cross section when viewed in plan and the passage 14 is similarly dimensioned so that the post member is a snug, sliding fit in the passage.

The sleeve 12, being of a synthetic plastics material, provides a low friction bearing surface relative to which the post member 20, being of a metal material, such as stainless steel, can slide. If desired, walls of the passage 14 are fluted or ribbed to provide reduced friction.

Opposed ends of the post member 20 are closed off by end caps 62. The end caps 62 are of a suitable, synthetic plastics material and are a press-fit within their associated ends of the post member 20.

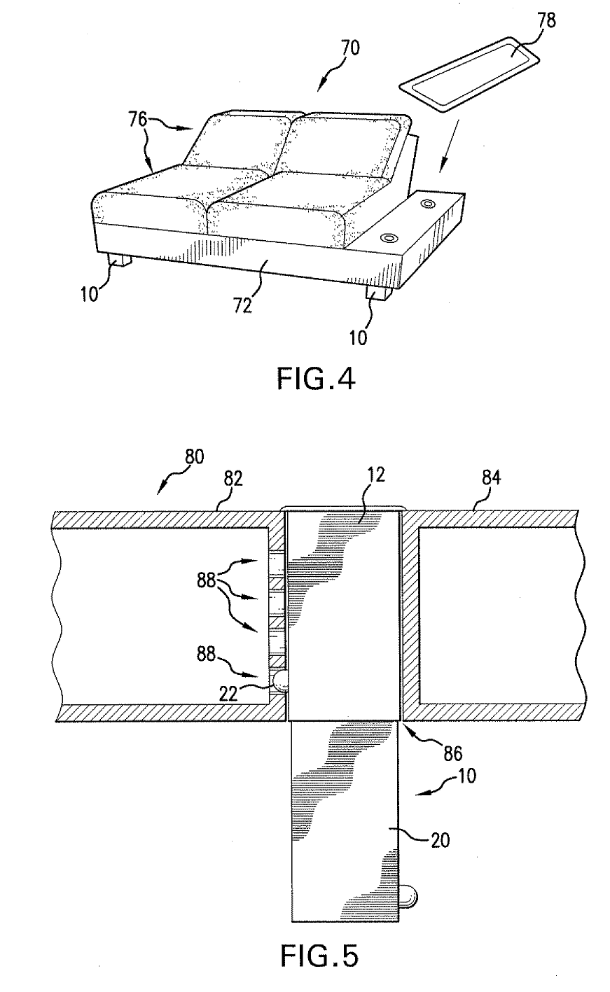

As indicated above the adjustable leg 10 is intended particularly for use in the furniture industry and, more particularly, as a leg for an article of furniture. An example of such an article of furniture is shown at 70 in FIG. 4 of the drawings. The article of furniture may be a sofa, as illustrated, having a base portion 72 to which the adjustable legs 10 are attached. The article of furniture 70, further, has cushion members 76 and, if desired, removable accessories 78.

As illustrated more clearly in FIG. 5 of the drawings, the base portion 72 of the article of furniture 70 comprises a frame component 80. The frame component 80 is of a steel construction and has a pair of opposed frame elements 82, 84 defining a socket 86 between them. The sleeve 12 of the adjustable leg 10 is receivable in the socket 86 between the frame elements 82 and 84. It is to be noted that the frame element 82 has a plurality of receiving regions or apertures 88. When the sleeve 12 is received in the socket 86, the apertures 88 align with the openings 16 in the face 18 of the sleeve 12 of the adjustable leg 10. The engaging element 22 is therefore partially received in the aperture 88 aligned with that opening 16 through which the engaging element 22 projects. In this way, improved retention strength is provided by the frame element 82 of the frame component 80 for retaining the post member 20 in its adjusted position relative to the sleeve 12.

It will be appreciated that, in certain circumstances, the sleeve 12 could be omitted and the post member 20 could be received directly in the socket 86 of the frame component 80 of the article of furniture 70. In that case, the frame 80 defines the receptacle relative to which the post member 20 is adjustable. It is, however, preferable to provide the sleeve 12 to provide a suitable, low friction medium for sliding movement of the post member 20 relative to the frame 80. With the provision of the sleeve 12 the likelihood of the post member 20 jamming in the socket 86 is reduced.

It is an advantage of embodiments of the present disclosure that an adjustable leg is provided which is easy to operate and to effect adjustment of the height of the article of furniture 70 to which the adjustable leg 10 is attached. The adjustable leg 10 also provides an attractive appearance to the finished article of furniture 70.

It will be appreciated by persons skilled in the art that numerous variations and/or modifications may be made to the embodiments described above. The present embodiments are, therefore, to be considered in all respects as illustrative and not restrictive.

1. An adjustable leg for an article of furniture, the adjustable leg comprising:
a receptacle defining a plurality of receiving formations; and
a post member displaceably received in the receptacle, the post member carrying an engaging element which is selectively releasably receivable in one of the receiving formations of the receptacle and an operating member to which the engaging element is responsive for making and breaking engagement between the engaging element and the selected one of the receiving formations of the receptacle.

2. An adjustable leg according to claim 1, wherein the receptacle is a part of the article of furniture.

3. An adjustable leg according to claim 1, wherein the receptacle is a sleeve which cooperates with a frame component of the article of furniture.

4. An adjustable leg according to claim 3, wherein the sleeve cooperates with the article of furniture by being received in a socket of the frame component of the article of furniture.

5. An adjustable leg according to claim 1, wherein the receptacle and the post member are shaped to inhibit relative rotation between the receptacle and the post member.

6. An adjustable leg according to claim 1, wherein at least one of the receptacle and the post member comprises a bearing surface of a low friction material to facilitate sliding displacement between the receptacle and the post member.

7. An adjustable leg according to claim 1, wherein the receptacle has at least one face in which the receiving formations are arranged.

8. An adjustable leg according to claim 7, wherein the receiving formations are arranged in aligned, longitudinally spaced relationship in the face of the receptacle.

9. An adjustable leg according to claim 1, wherein the post member comprises at least one pair of opposed sides and the engaging clement is projectable through a first side of the pair of opposed sides of the post member and the operating member is projectable through an opposed, second side of the pair of opposed sides of the post member.

10. An adjustable leg according to claim 9, wherein the operating member comprises an operating button projectable through the second side of the post member, the operating button being mounted to one end of a lever arm.

11. An adjustable leg according to claim 10, wherein the engaging element is carried by an opposed end of the lever arm.

12. An adjustable leg according to claim 11, wherein the lever arm is pivotally arranged within the post member.

13. An adjustable leg according to claim 12, comprising an urging device which acts on the lever arm so that, in a rest condition, the lever arm is arranged within the post member so that the engaging element projects from its associated side of the post member.

14. An adjustable leg according to claim 13, wherein the lever arm and urging device are adapted such that depression of the operating button against the action of the urging device disengages the engaging element from the receiving formation and moves the engaging element into the interior of the post member.

15. An adjustable leg according to claim 13, wherein the urging device is interposed between the lever arm and an inner surface of one of the first and second sides of the post member.

16. An adjustable leg according to claim 10, wherein the lever arm is doglegged, having a first part carrying the operating button on a first surface and a second part, arranged at an obtuse angle to the first part, carrying the engaging element on an opposed, second surface.

17. An adjustable leg according to claim 16, wherein the lever arm is pivotally mounted, about a pivot point, in the post member at a transition between the first part and the second part, the pivot point being defined by the transition bearing against an inner surface of one of the first and second sides of the post member.

18. An article of furniture comprising:
a frame component; and
at least one adjustable leg mounted to the frame component, the adjustable leg comprising:
a receptacle defining a plurality of receiving formations; and
a post member displaceably received in the receptacle, the post member carrying an engaging element which is selectively releasably receivable in one of the receiving formations of the receptacle and an operating member to which the engaging element is responsive for making and breaking engagement between the engaging element and the selected one of the receiving formations of the receptacle.

19. An article of furniture according to claim 18, wherein the receptacle of the adjustable leg is received within a socket defined in the frame component, a wall of the socket defining receiving regions which are in register with the receiving formations of the receptacle of the adjustable leg when the receptacle of the adjustable leg is received in the socket.

20. A component for an adjustable leg, the component comprising:
a hollow body member defining a plurality of faces;
an engaging element carried by the body member to protrude through an opening in a first face of the body member; and
an operating member carried by the body member and which acts on the engaging element to effect displacement of the engaging element relative to the body member, the operating member comprising an operating element accessible through one of the faces of the body member for effecting displacement of the engaging element relative to the body member.

21. A component according to claim 20, wherein the operating member comprises an operating button and a lever arm, with the operating button being mounted proximate one end of the lever arm and the engaging element being mounted proximate an opposed end of the lever arm.
